(19) United States
(12) Patent Application Publication
(10) Pub. No.: US 2008/0061541 A1
(43) Pub. Date: Mar. 13, 2008

(54) Inflator

(75) Inventor: Kanji Yano, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 11/822,304

(22) Filed: Jul. 5, 2007

(30) Foreign Application Priority Data
Sep. 7, 2006 (JP) 2006-242539

(51) Int. Cl. B60R 21/26

(52) U.S. Cl. 280/741

(57) ABSTRACT

An inflator supplies gas into an airbag mounted on a motor vehicle and deploys the airbag. The inflator includes a first chamber wherein a gas blowing-outlet is provided and a gas-generating agent generating the gas by being ignited by an initiator is encapsulated. A filter is interposed between the gas blowing-outlet of the first chamber and the gas-generating agent. A second chamber is attached to the first chamber with a flow amount control member interposed therebetween, wherein compressed gas is encapsulated. A blocking member blocks a control hole of the flow amount control member so that the control hole is opened by being ruptured or removed by expanding pressure of the gas-generating agent.

### BACKGROUND OF THE INVENTION AND RELATED ART STATEMENT

The present invention relates to an inflator (gas generator) that is equipped on a motor vehicle (automobile), which inflates and deploys an airbag, such as a curtain airbag or the like for restraining an occupant when a rollover (overturn) or the like of the motor vehicle occurs.

As for a conventional art, it is common that an airbag has gas generators (inflator) for inflating an airbag for the purpose of safety of a motor vehicle and is provided with a main body including an ignition device (initiator), and a reservoir (gas-chamber) connected to the main body for housing a compressed gas, and further provided with a discharging orifice where the reservoir is blocked in an initial stage. It is known that the gas generator in the aforementioned main body includes a first gunpowder capable of generating a predetermined amount of gas for inflating the airbag in a period within 50 msec while being associated with the predetermined amount of gas housed in the reservoir, and a second gunpowder capable of generating a sufficient amount of gas for keeping the airbag inflated for several seconds after the first gunpowder has burnt (for example, refer to Japanese Unexamined Patent Application Publication No. 2003-81050).

However, according to the aforementioned conventional technology, when a hole diameter of the discharging orifice is set so that the airbag is inflated within 50 msec by means of the first gunpowder, a discharging time for discharging the compressed gas generated by means of the second gunpowder becomes short, and when the hole diameter of the discharging orifice is set to be small so that the discharging time for discharging the compressed gas generated by means of the second gunpowder becomes long, a strength of a first impact by means of the first gunpowder (initial rapid deployment of the airbag) becomes weak. This is because the discharging orifice for discharging the gas is directly provided in the reservoir for housing the compressed gas at an opposite side of the main body for housing the gunpowder. Consequently, it has been a problem that it is difficult to satisfy both of a strength of a first impact of the airbag and a long inflation time of the airbag.

The present invention is made to overcome the above-described problems and an object of the present invention is to obtain an inflator capable of satisfying both of a strength of a first impact of the airbag and a long inflation time of the airbag.

Further objects and advantages of the invention will be apparent from the following description of the invention.

### SUMMARY OF THE INVENTION

In order to solve the above-described problems, and to achieve the objects, an inflator according to the first aspect of the invention is that the inflator supplies gas into an airbag mounted on a motor vehicle for deploying the airbag. The inflator includes a first chamber where a gas blowing-outlet is provided and a gas-generating agent generating the gas by being ignited by an initiator is encapsulated, a filter intervening between a gas blowing-outlet of the first chamber and the gas-generating agent, and absorbing heat of combustion of the gas-generating agent, and capturing a residue of the gas-generating agent, a second chamber partitioned from the first chamber with a flow amount control member where compressed gas is encapsulated, and a blocking member of a control hole of the flow amount control member for opening the control hole by being ruptured or removed by expanding pressure of the gas-generating agent.

The present invention according to the second aspect of the invention is that, in the inflator according to the first aspect of the invention, the first and second chambers are formed in a cylindrical housing, and the gas blowing-outlet is formed to be directed to a radial direction in an outer peripheral portion of the cylindrical housing.

The present invention according to the third aspect of the invention is that, in the inflator according to the second aspect of the invention, the filter is formed into a cylindrical shape and is installed in a close contact manner to an inner wall of the first chamber.

The present invention according to the fourth aspect of the invention is that, in the inflator according to any one of the first to third aspects of the invention, the compressed gas contains nitrous oxide gas.

The present invention according to the fifth aspect of the invention is that, in the inflator according to any one of the first to fourth aspects of the invention, the airbag is a curtain airbag capable of deploying at a side portion of a vehicle interior.

According to the present invention described in the first aspect of the invention, both of a strength of a first impact of the airbag and a long inflation time of the airbag can be satisfied.

According to the present invention described in the second aspect of the invention, gas generated by the gas-generating agent in the first chamber can rapidly be blown out, and the compressed gas in the second chamber can slowly be blown out.

According to the present invention described in the third aspect of the invention, the first impact of the airbag can be strengthened by enlarging a square measure of a filter, and reducing a passing resistance of the gas generated by the gas-generating agent.

According to the present invention described in the fourth aspect of the invention, nitrous oxide gas is decomposed by heat of the filter into nitrogen and oxygen (2N₂O→2N₂+O₂), and the total number of gas moles becomes 1.5 times greater than that of the nitrous oxide gas before decomposition thereof. Therefore, the cylindrical housing can be made compact.

According to the present invention described in the fifth aspect of the invention, both of the strength of the first impact of the airbag and the long inflation time of the airbag can be satisfied.

### BRIEF DESCRIPTION OF THE DRAWINGS

FIG. 1 is a cross-sectional view showing an embodiment of an inflator according to the present invention.

FIG. 2 is a cross-sectional view showing a condition just after the initiator is ignited.

FIG. 3 is a cross-sectional view showing a condition after approximately one second has passed from ignition of the initiator.

FIG. 4 is a view showing a characteristic of inner pressure of the curtain airbag versus time.

### DETAILED DESCRIPTION OF PREFERRED EMBODIMENTS

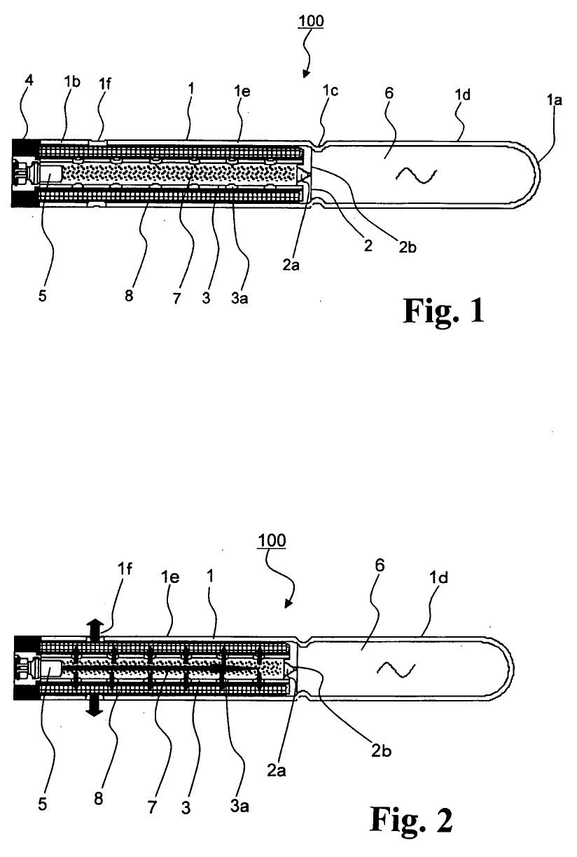

Hereinafter, an embodiment of the present invention will be explained with reference to the drawings. FIG. 1 is a cross-sectional view illustrating an embodiment of an inflator according to the present invention.

As illustrated in FIG. 1, an inflator 100 of the present embodiment is appropriate for an inflator for use in a curtain airbag (not shown) capable of being deployed at, for example, a side portion of a vehicle interior. A housing thereof is formed into a cylindrical housing 1 with a similar shape as that of a test tube where a bottom portion 1a having a hemisphere shape is formed at an end and an opening portion 1b is formed at the other end, and further, a narrowed portion 1c is formed in a middle portion thereof.

In the narrowed portion 1c of the cylindrical housing 1, an orifice plate 2 serving as a flow amount control member inserted from an opening portion 1b side is fixed in an air-tight manner. At a center portion of the orifice plate 2, an orifice 2a serving as a control hole to be an air flow resistance is formed. A diameter of the orifice 2a is set to be about 1 mm, and is blocked by means of a metal thin plate 2b with a thickness of about 0.4 mm that serves as a blocking member.

The cylindrical housing 1 is partitioned into a first chamber 1d and a second chamber 1e by means of the orifice plate 2. At a position situated nearer the opening portion 1b in the first chamber 1e, four gas-blowing outlets 1f each directed to a radial direction are formed. In the first chamber 1e, an inner tube 3 where numerous gas holes 3a are formed over an entire length thereof is inserted. A diameter of the inner tube 3 is set to about half of a diameter of the cylindrical housing 1, and therefore one end of the inner tube 3 is latched on the orifice plate 2 and the other end thereof is latched on a mouthpiece 4 obstructing the opening portion 1b of the cylindrical housing 1.

In the second chamber 1d, a compressed gas (200 to 300 kPa) 6 of a helium gas, an argon gas, a nitrogen gas, air, a carbon dioxide gas, nitrous oxide gas, or the like is encapsulated. Further, a gas-generating agent 7 is encapsulated in the inner tube 3 of the first chamber 1e, and at an outside of the inner tube 3, a filter 8 that absorbs and reserves heat of combustion of the gas-generating agent 7, and that captures a residue of the gas-generating agent 7 is inserted.

The filter 8 is formed into a cylindrical shape from a metal-made mesh material and is installed in an inner wall of the first chamber 1e in a close contact manner therewith. An initiator (ignition device) 5 is mounted on the mouthpiece 4 in an air-tight manner. The compressed gas 6 is injected from an injecting hole, which is not shown, provided in the second chamber 1d.

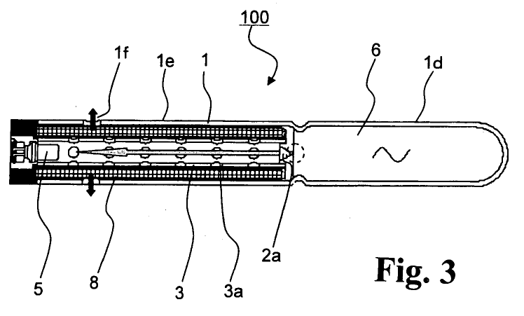

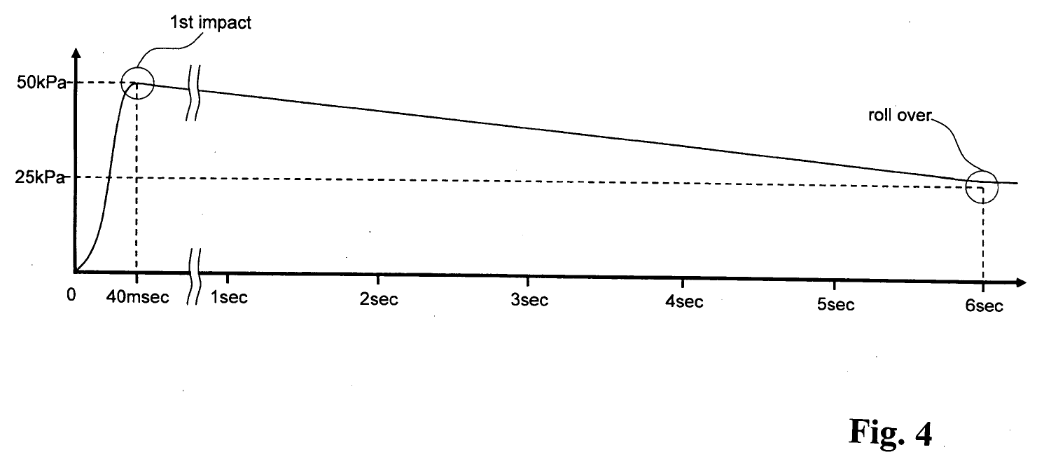

FIG. 2 is a cross-sectional view showing a condition just after the initiator 5 is ignited, FIG. 3 is a cross-sectional view showing a condition after approximately one second has passed from ignition of the initiator, and FIG. 4 is a view showing a characteristic of inner pressure of the curtain airbag versus time. Next, with reference to FIGS. 2 through 4, an operation of the inflator 100 of the embodiment will be explained. When a collision, an overturn, or the like of a motor vehicle occurs, a sensor, not shown, detects the same, an electric signal is transmitted to the initiator 5, and the initiator 5 is ignited.

By means of the ignition of the initiator 5, as shown in FIG. 2, the gas-generating agent 7 is ignited, and the gas-generating agent 7 is combusted. The high temperature and high pressure gas is thereby generated. The generated gas passes through a gas hole 3a of the inner tube 3 and the filter 8 having a relatively wide square measure, without receiving a relatively large passing resistance, and blows out from a gas blowing-out hole 1f of the cylindrical housing 1. As shown in FIG. 4, after about 40 msec of the ignition of the initiator 5, as a first impact, the inner pressure of the curtain airbag is raised up to approximately 50 kPa and the same is inflated and deployed.

At the same time of the aforementioned operation, by means of expansion pressure at 300 kPa or more in the first chamber 1e, which is generated by the gas-generating agent 7, as shown in FIG. 2, the metal thin plate 2b blocking the orifice 2a is ruptured or removed. A flowing speed of the compressed gas 6 encapsulated in the second chamber 1d is controlled by receiving a flow resistance of the orifice 2a, and the compressed gas 6 flows into the first chamber 1e at a slow speed, as shown in FIG. 3.

The flowing speed of the compressed gas 6 flowing into the first chamber 1e is further reduced by receiving a resistance of the filter 8 where the flowing resistance is increased by a clogging of the residue of the gas-generating agent 7. Further, the compressed gas 6 flows into an inside of the curtain airbag as the gas for a rolling over while being heat expanded by receiving the heat of the filter 8 where the heat of combustion of the gas-generating agent 7 is reserved.

As shown in FIG. 4, the inner pressure of the curtain airbag is kept at about 25 kPa or more for about 6 seconds or more from the ignition of the initiator 5, while gradually lowering the inner pressure from approximately 50 kPa by the compressed gas flowing in at a lower speed (for the rolling over).

When the nitrous oxide gas (N₂O) is added to the compressed gas 6, the nitrous oxide gas (N₂O) is decomposed by heat of the filter 8 into nitrogen and oxygen (2N₂O→2N₂+O₂), and the total number of gas moles becomes 1.5 times greater than that of the nitrous oxide gas before decomposition thereof. Therefore, size of the cylindrical housing 1 can be reduced.

As explained above, the inflator 100 according to the present embodiment is configured to be a two-phase curtain airbag inflator where a gas supplying operation by means of the gas generator 7 for satisfying a first impact capability, and the gas supplying operation by means of the compressed gas 6 for satisfying a rolling over capability are designed to perform separate functions, and the gas required for each of the capabilities can be supplied at minimum and necessary amount for only necessary amount of time. As a result, a load for the airbag can be successfully reduced.

Further, because the gas can be continuously supplied to the airbag for a long time after the first impact occurs, a sealing member of an airbag-stitching portion can be eliminated.

The disclosure of Japanese Patent Application No. 2006-242539 filed on Sep. 7, 2006 is incorporated as a reference.

While the invention has been explained with reference to the specific embodiments of the invention, the explanation is illustrative and the invention is limited only by the appended claims.

What is claimed is:

1. An inflator for supplying gas into an airbag mounted on a motor vehicle and deploying the airbag, comprising:
a first chamber having a gas blowing-outlet and containing an initiator and a gas-generating agent generating the gas by being ignited by the initiator;
a filter for covering the gas blowing-outlet of the first chamber, said filter absorbing heat of combustion of the gas-generating agent, and capturing a residue of the gas-generating agent;
a second chamber attached to the first chamber and containing compressed gas therein; and
a flow amount control member partitioning the first and second chambers, said flow amount control member being ruptured by gas of the gas-generating agent so that the compressed gas is ejected after the gas from the gas-generating agent is ejected.

2. The inflator according to claim 1, wherein said flow amount control member includes a hole, and a blocking member for blocking the hole, said blocking member being ruptured by the gas of the gas-generating agent.

3. The inflator according to claim 1, wherein said filter is interposed between the gas blowing-outlet of the first chamber and the gas-generating agent.

4. The inflator according to claim 2, wherein the first and second chambers are formed in a cylindrical housing, and the gas blowing-outlet is formed to be directed to a radial direction in an outer peripheral portion of the cylindrical housing.

5. The inflator according to claim 3, wherein the filter is formed into a cylindrical shape and is installed closely to an inner wall of the first chamber.

6. The inflator according to claim 1, wherein the compressed gas contains nitrous oxide gas.

7. The inflator according to claim 1, wherein the airbag is a curtain airbag capable of deploying at a side portion of a vehicle interior.

8. The inflator according to claim 1, wherein the filter has a size to be clogged by residues of the gas-generating agent after the combustion for slowing down a speed of gas flow from the second gas chamber.
